(19) United States
(12) Patent Application Publication
(10) Pub. No.: US 2021/0186043 A1
(43) Pub. Date: Jun. 24, 2021

(54) NON-HYDROGENATED MIXED BUTTERFAT AND NON-DAIRY CREAM, AND PREPARATION METHOD THEREFOR

(71) Applicant: SHANGHAI HI-ROAD FOOD TECHNOLOGY CO., LTD., Shanghai (CN)

(72) Inventor: Haihu HUANG, Shanghai (CN)

(73) Assignee: SHANGHAI HI-ROAD FOOD TECHNOLOGY CO., LTD., Shanghai (CN)

(21) Appl. No.: 16/075,961

(22) PCT Filed: Nov. 28, 2016
(86) PCT No.: PCT/CN2016/107571

§ 371 Date: Aug. 7, 2018

(30) Foreign Application Priority Data
Mar. 27, 2016 (CN) 201610181635.5

(51) Int. Cl. A23D 7/005; A23C 13/14; A23D 7/04; A23D 7/06; A23L 29/10; A23D 7/01; A23L 29/256; A23L 29/262

(52) U.S. Cl. CPC A23D 7/0053; A23C 13/14; A23D 7/04; A23D 7/06; A23V 2002/00; A23D 7/011; A23L 29/256; A23L 29/262; A23L 29/10

(57) ABSTRACT

A non-hydrogenated mixed dairy and non-dairy cream includes the following raw materials in weight percent: non-hydrogenated vegetable oil: 8%-18%; sorbitan monostearate: 0.05%-0.5%; stearyl monoglyceridyl citrate: 0.02%-0.5%; mono- and diglycerides of fatty acids: 0.05%-1%; lactate monoglyceride: 0.02%-1%; sodium stearoyl lactylate: 0.02%-0.5%; sucrose fatty acid ester: 0.05%-0.5%; polyglycerol ester: 0.02%-0.5%; carrageenan: 0.01%-0.1%; microcrystalline cellulose: 0.05%-0.8%; modified cellulose: 0.05%-1%; sodium caseinate: 0.1%-1.5%; potassium dihydrogen phosphate: 0.02%-0.2%; sugar: 2%-6%; glucose syrup: 2%-12%; fat-containing dairy product: 8%-18%; and water: 20%-60%.

### TECHNICAL FIELD

The present invention relates to a cream and preparation method thereof, in particular to a non-hydrogenated mixed dairy and non-dairy cream and preparation method thereof.

### BACKGROUND ART

In China's traditional non-dairy cream production, hydrogenated vegetable oil is the main raw material. Hydrogenated vegetable oil is artificial oil, which is produced by catalytic hydrogenation of common vegetable oils under certain temperature and pressure. The hydrogenated vegetable oil system is uniform, has no odor, and its hardness increases, with a high melting point, so that it can maintain a solid shape at room temperature, and its plasticity, fusion, and emulsification are increased. In addition, it can extend the shelf life of products; therefore, it has been widely used in food processing. However, some hydrogenated vegetable oils that have not been fully hydrogenated contain trans-fatty acids, which do not have the nutrients of pure natural vegetable oils and are not good for human health. Trans-fatty acids easily induce coronary heart disease, heart disease, arteriosclerosis, obesity and diabetes, and etc. In addition to generation of some trans-fatty acids, some metal catalysts may remain in the process of hydrogenated oil processing. These substances have impacts on human health, which severely limits the safety of their application in food processing.

Today, with the increasing demand for high quality livings, people are more concerned about the food safety. Health and safety have become the primary criteria for consumers to purchase products. Therefore, it is necessary to use non-hydrogenated vegetable oil instead of hydrogenated vegetable oil in food processing. Non-hydrogenated fats and oils are derived from pure natural plants that are not hydrogenated. Because they are not hydrogenated, they do not contain trans fatty acids. This is beneficial to human health. In terms of nutrition, it is nutritious and does not contain trans fatty acids and cholesterol, with high content of unsaturated fatty acids. In addition, because non-hydrogenated vegetable oil can be normally involved in the human metabolism, with high nutritional value and benefits human health, it is ideal edible oil. However, when non-hydrogenated oils and fats are used in foods, they have the shortcomings of soft texture, difficulty in operation and poor flavor and taste, which seriously limit their applications in food processing. Therefore, in order to solve the above problems, in the present invention, by using mixed emulsifiers and stabilizers and combining two non-hydrogenated oils and fats, these shortcomings of non-hydrogenated oils and fats can be overcome. The emulsification uniformity, stability, operability and tastes of the non-hydrogenated oils/fats are improved, to prepare non-hydrogenated mixed dairy and non-dairy cream, enhancing the nutritional value and health properties of the products. The cream prepared in the invention has good taste and flavor, with a stable system, meeting needs of customers.

### SUMMARY OF THE INVENTION

An object of the present invention is to provide a non-hydrogenated mixed dairy and non-dairy cream and a preparation method thereof, to solve the foregoing problems in the prior art.

To achieve the above object, the present invention provides a non-hydrogenated mixed dairy and non-dairy cream, comprising the following raw materials in weight percent:

non-hydrogenated vegetable oil: 8%-18%;

sorbitan monostearate: 0.05%-0.5%;

stearyl monoglyceridyl citrate: 0.02%-0.5%;

mono- and di-glycerides of fatty acids: 0.05%-1%;

lactate monoglyceride: 0.02%-1%;

sodium stearoyl lactylate: 0.02%-0.5%;

sucrose fatty acid ester: 0.05%-0.5%;

polyglycerol ester: 0.02%-0.5%;

carrageenan: 0.01%-0.1%;

microcrystalline cellulose: 0.05%-0.8%;

modified cellulose: 0.05%4%;

sodium caseinate: 0.1%-1.5%;

potassium dihydrogen phosphate: 0.02%-0.2%;

sugar: 2%-6%;

glucose syrup: 2%-12%;

fat-containing dairy product: 8%-18%;

water: 20%-60%.

The non-hydrogenated vegetable oil is prepared from refined palm oil and coconut oil; the ratio of the refined palm oil to the coconut oil is 9-10:2-3.

Further, the present invention provides a method for preparing a non-hydrogenated mixed dairy and non-dairy cream using non-hydrogenated vegetable oils as raw materials. The non-hydrogenated cream made by this method has good flavor and taste and operability, mainly comprising the following steps:

Melt and heat non-hydrogenated vegetable oil to 60-65° C.; add sorbitan monostearate, stearyl monoglyceridyl citrate, lactate monoglyceride, sodium stearoyl lactylate, mono- and diglycerides of fatty acids, sucrose fatty acid ester, polyglycerol ester, carrageenan, microcrystalline cellulose, modified cellulose and sodium caseinate, and potassium dihydrogen phosphate; stir the mixture to disperse evenly to obtain an oil-phase mixture. Dissolve sugar, glucose syrup, and fat-containing dairy product in water at 60-70° C. to obtain an aqueous-phase mixture. Add the aqueous phase to the oil phase, stir evenly and perform pasteurization. Then, perform homogenization, and stir it at a temperature of below 10° C. for 1 hour. Perform filling and preserve the product under a frozen condition below −18° C.

The non-hydrogenated vegetable oil in the present invention is made by mixing non-hydrogenated refined palm kernel oil and coconut oil.

The present invention can achieve the following beneficial effects: first, by using non-hydrogenated vegetable oils instead of hydrogenated vegetable oil as raw materials, which contain no trans-fatty acids, it can meet people's demands for healthy and nutritious food nowadays. Second, non-hydrogenated vegetable oils are used as raw materials to prepare mixed dairy and non-dairy cream. Through the synergistic effect of the emulsifiers, the disadvantages, such as soft texture, difficulty to operate and poor tastes and flavors, are overcome during the production of mixed dairy and non-dairy cream using non-hydrogenated vegetable oils, so as to meet the quality requirements of customers.

### DETAILED DESCRIPTIONS

The present invention is further described in combination with particular examples.

### Example 1: Non-Hydrogenated Mixed Dairy and Non-Dairy Cream

Obtain non-hydrogenated palm kernel oil 100 g, non-hydrogenated coconut oil 30 g, sorbitan monostearate 3.5 g, stearyl monoglyceridyl citrate 1.5 g, mono- and diglycerides of fatty acids 2.5 g, lactate monoglyceride 2.3 g, sodium stearoyl lactylate 2.5 g, sucrose fatty acid ester 2.5 g, polyglycerol ester 0.5 g, carrageenan 0.2 g, microcrystalline cellulose 4 g, modified cellulose 1.5 g, sodium caseinate 4 g, potassium dihydrogen phosphate 1 g, sugar 60 g, glucose syrup 45 g and whipping cream 250 g, water 489 g.

Preparation Process:

Melt and heat non-hydrogenated vegetable oil to 60-65° C.; add sorbitan monostearate, stearyl monoglyceridyl citrate, lactate monoglyceride, sodium stearoyl lactylate, mono- and diglycerides of fatty acids, sucrose fatty acid ester, polyglycerol ester, carrageenan, microcrystalline cellulose, modified cellulose, sodium caseinate, and potassium dihydrogen phosphate; stir to disperse the resulting mixture evenly to obtain an oil-phase mixture. Dissolve sugar, glucose syrup, and milk fat in water at 60° C. to obtain an aqueous phase. Add the aqueous phase to the oil phase, stir evenly at 70 rpm and heat to sterilize. Then, perform homogenization, and stir it at a temperature below 10° C. for 1 hour. Perform filling and preserve the product under a frozen condition below −18° C. The homogenization conditions: 30 Mpa, homogenize once, sterilization temperature of 63° C., time of 45 minutes.

The mixed dairy and non-dairy cream prepared by the above method has no trans-fatty acids by testing, and its texture is not soft any longer, with good operability, good flavor and taste, and free of vegetable oil tastes. Its whipping foam rate is 4.2 and whipping time is 6 minutes. The results compared with the creams made by hydrogenated oils are shown in the table 1.

TABLE 1
Comparison of non- hydrogenated and hydrogenated non-dairy cream

| | Trans fatty | | | Flavor and | Whipping |
|---|---|---|---|---|---|
| | acid content | Operability | Texture | taste | rate |
| non-hydrogenated | 0 | Good | Moderate, | Quick melted | 4.2 |
| non-dairy cream | | | high stiffness | when eating, | |
| | | | after whipping | no taste of | |
| | | | | vegetable oil | |
| hydrogenated | 0.1-0.3 | Good | Soft, easy to | Slowly melted | 4.0 |
| non-dairy cream | | | deform after | when eating | |
| | | | whipping | | |

### Example 2: Non-Hydrogenated Mixed Dairy and Non-Dairy Cream

Take non-hydrogenated palm kernel oil 90 g, non-hydrogenated coconut oil 20 g, sorbitan monostearate 3.5 g, stearyl monoglyceridyl citrate 1.0 g, mono- and diglycerides of fatty acids 2.5 g, lactate monoglyceride 3.8 g, sodium stearoyl Lactylate 2.5 g, sucrose fatty acid ester 2.5 g, polyglycerol ester 0.5 g, carrageenan 0.2 g, microcrystalline cellulose 3.5 g, modified cellulose 2.0 g, sodium caseinate 4 g, potassium dihydrogen phosphate 1 g, sugar 60 g, glucose Syrup 45 g and whipping cream 290 g, water 469 g.

Preparation Process:

Melt and heat non-hydrogenated vegetable oil to 65° C., and then add sorbitan monostearate, stearyl monoglyceridyl citrate, lactate monoglyceride, sodium stearoyl lactylate, mono- and diglycerides of fatty acids, sucrose fatty acid ester, polyglycerol ester, carrageenan, microcrystalline cellulose, modified cellulose and sodium caseinate, and potassium dihydrogen phosphate. Stir to disperse the resulting mixture evenly to obtain an oil-phase mixture. Dissolve sugar, glucose syrup, and milk fat in water at 70° C. to obtain an aqueous phase. Add the aqueous phase to the oil phase; stir the mixture evenly at 70 rpm and heat to sterilize. Then, perform homogenization, and stir slowly at a temperature at or below 10° C. for 1 hour. Perform filling and preserve the product under a frozen condition below −18° C. The homogenization conditions: 60 Mpa, homogenize twice; sterilization temperature of 70° C., time of 25 minutes.

The mixed dairy and non-dairy cream prepared by the above method has no trans-fatty acids by testing, and its texture is not soft any longer, with good operability, good flavor and taste, and free of vegetable oil tastes. Its whipping foam rate is 4.1 and whipping time is 7 minutes. The results compared with the creams made by hydrogenated oils are shown in the table 2.

TABLE 2
Comparison of non- hydrogenated and hydrogenated non-dairy cream

| | Trans fatty | | | Flavor and | Whipping |
|---|---|---|---|---|---|
| | acid content | Operability | Texture | taste | rate |
| non-hydrogenated | 0 | Good | Moderate, | Quick melted | 4.1 |
| non-dairy cream | | | high stiffness | when eating, | |
| | | | after whipping | no taste of | |
| | | | | vegetable oil | |
| hydrogenated | 0.1-0.3 | Good | Soft, easy to | Slowly melted | 4.0 |
| non-dairy cream | | | deform after | when eating | |
| | | | whipping | | |

### Example 3: Non-Hydrogenated Mixed Dairy and Non-Dairy Cream

Take non-hydrogenated palm kernel oil 95 g, non-hydrogenated coconut oil 25 g, sorbitan monostearate 3.5 g, stearyl monoglyceridyl citrate 1.5 g, mono- and diglycerides of fatty acids 2.5 g, lactate monoglyceride 3.5 g, sodium stearoyl Lactylate 2.5 g, sucrose fatty acid ester 2.5 g, polyglycerol ester 0.5 g, carrageenan 0.2 g, microcrystalline cellulose 3 g, modified cellulose 2.5 g, sodium caseinate 4 g, potassium dihydrogen phosphate 1 g, sugar 60 g, glucose syrup 45 g and whipping cream 270 g, water 477.8 g.

Preparation Process:

Melt and heat non-hydrogenated vegetable oil to 65° C., and then add sorbitan monostearate, stearyl monoglyceridyl citrate, lactate monoglyceride, sodium stearoyl lactylate, mono- and diglycerides of fatty acids, sucrose fatty acid ester, polyglycerol ester, carrageenan, microcrystalline cellulose, modified cellulose, sodium caseinate, and potassium dihydrogen phosphate. Stir the resulting mixture to disperse evenly to obtain an oil-phase mixture. Dissolve sugar, glucose syrup and milk fat in water at 70° C. to obtain an aqueous phase. Add the aqueous phase to the oil phase, and stir evenly at 70 rpm and heat to sterilize. Then, perform homogenization, and stir slowly at a temperature at or below 10° C. for 1 hour. Perform filling and preserve the product under a frozen condition below −18° C. The homogenization conditions: 60 Mpa, homogenize twice, sterilization temperature of 70° C., time of 25 minutes.

The mixed dairy and non-dairy cream prepared by the above method has no trans-fatty acids by testing, and its texture is not soft any longer, with good operability, good flavor and taste, and free of vegetable oil tastes. Its whipping foam rate is 4.3 and whipping time is 6.5 minutes. The results compared with the creams made by hydrogenated oils are shown in the table 3.

TABLE 3
Comparison of non- hydrogenated and hydrogenated non-dairy cream

| | Trans fatty | | | Flavor and | Whipping |
|---|---|---|---|---|---|
| | acid content | Operability | Texture | taste | rate |
| non-hydrogenated | 0 | Good | Moderate, | Quick melted when | 4.2 |
| non-dairy cream | | | high stiffness | eating, no taste of | |
| | | | after whipping | vegetable oil | |
| hydrogenated | 0.1-0.3 | Good | Soft, easy to | Slowly melted when | 4.0 |
| non-dairy cream | | | deform after | eating | |
| | | | whipping | | |

### COMPARATIVE EXAMPLE

The comparative example is mainly to investigate the effect of synergistic use of emulsifiers and stabilizers on the performance of the cream products, focusing on investigating the effect of synergistic use of stearyl monoglyceridyl citrate and mono- and diglycerides of fatty acids.

Preparation method: Melt and heat non-hydrogenated vegetable oil to 65° C., add sorbitan monostearate, stearyl monoglyceridyl citrate, lactate monoglyceride, sodium stearoyl lactylate, mono- and diglycerides of fatty acids, sucrose fatty acid ester, polyglycerol ester, carrageenan, microcrystalline cellulose, modified cellulose and sodium caseinate, potassium dihydrogen phosphate, and stir to disperse evenly, to obtain an oil-phase mixture; dissolve sugar, glucose syrup and milk fat in water at 70° C. Add aqueous phase to the oil phase, stir evenly at 70 rpm and heat to sterilize, then perform homogenization; and stir slowly it at a temperature of below 10° C. for 1 hour; perform filling and preserve under a frozen condition below −18° C. The homogenization conditions: 60 Mpa, homogenize twice, sterilization temperature of 70° C., time of 25 minutes.

### Comparative Example 1

Ingredients: non-hydrogenated palm kernel oil 95 g, non-hydrogenated coconut oil 25 g, sorbitan monostearate 3.5 g, stearyl monoglyceridyl citrate 0 g, mono- and diglycerides of fatty acids 2.5 g, lactate monoglyceride 3.5 g, sodium stearoyl lactylate 2.5 g, sucrose fatty acid ester 2.5 g, polyglycerol ester 0.5 g, carrageenan 0.2 g, microcrystalline cellulose 3 g, modified cellulose 2.5 g, sodium caseinate 4 g, potassium dihydrogen phosphate 1 g, sugar 60 g, glucose syrup 45 g and whipping cream 270 g, water 477.8 g.

### Comparative Example 2

Ingredients: non-hydrogenated palm kernel oil 95 g, non-hydrogenated coconut oil 25 g, sorbitan monostearate 3.5 g, stearyl monoglyceridyl citrate 1.5 g, mono- and diglycerides of fatty acids 0 g, lactate monoglyceride 3.5 g, sodium stearoyl lactylate 2.5 g, sucrose fatty acid ester 2.5 g, polyglycerol ester 0.5 g, carrageenan 0.2 g, microcrystalline cellulose 3 g, modified cellulose 2.5 g, sodium caseinate 4 g, potassium dihydrogen phosphate 1 g, sugar 60 g, glucose syrup 45 g and whipping cream 270 g, water 477.8 g.

Compare the stability, operability, stiffness after whipping and whipping rate of mixed dairy and non-dairy creams made from the above three comparative examples. The results are shown in the Table 4.

TABLE 4
Performances of mixed dairy and non-dairy cream products
made in the example 3 and comparative examples 1 and 2.

| | Performance Index | | | | |
|---|---|---|---|---|---|
| | | | Stiffness | | |
| | | | after | Flavor and | Whipping |
| Test Item | Stability | Texture | whipping | taste | rate |
| Comparative | Good | Moderate, | High | Delicate | 4.3 |
| example 1 | thermal | neither | stiffness, no | texture, quick | |
| | stability, | soft nor | deformation | melting after | |
| | uniform | hard | at room | eating, no taste | |
| | emulsification. | | temperature | of | |
| | | | for 3 hours. | non-hydrogenated | |
| | | | | vegetable oil | |
| Comparative | Poor thermal | Soft | Poor | Slow melting | 3.9 |
| example 2 | stability, | texture | stiffness, | after eating | |
| | stratification | | deformation | | |
| | of small | | at room | | |
| | amount of | | temperature | | |
| | oil and water | | for 1 hour. | | |
| Comparative | Poor thermal | Soft | Poor | Slow melting | 3.9 |
| example 3 | stability, | texture | stiffness, | after eating | |
| | stratification | | deformation | | |
| | of small | | at room | | |
| | amount of | | temperature | | |
| | oil and water | | for 1 hour. | | |

1. A non-hydrogenated mixed dairy and non-dairy cream, comprising the following raw materials in weight percent:
non-hydrogenated vegetable oil: 8%-18%;
sorbitan monostearate: 0.05%-0.5%;
stearyl monoglyceridyl citrate: 0.02%-0.5%;
mono- and diglycerides of fatty acids: 0.05%-1%;
lactate monoglyceride: 0.02%-1%;
sodium stearoyl lactylate: 0.02%-0.5%;
sucrose fatty acid ester: 0.05%-0.5%;
polyglycerol ester: 0.02%-0.5%;
carrageenan: 0.01%-0.1%;
microcrystalline cellulose: 0.05%-0.8%;
modified cellulose: 0.05%-1%;
sodium caseinate: 0.1%-1.5%;
potassium dihydrogen phosphate: 0.02%-0.2%;
sugar: 2%-6%;
glucose syrup: 2%-12%;
fat-containing dairy product: 8%-18%; and
water: 20%-60%.

2. The non-hydrogenated mixed dairy and non-dairy cream according to claim 1, wherein the non-hydrogenated vegetable oil is prepared from refined palm oil and coconut oil.

3. The non-hydrogenated mixed dairy and non-dairy cream according to claim 2, wherein a ratio of the refined palm oil to the coconut oil is 9-10:2-3.

4. A method for preparing the non-hydrogenated mixed dairy and non-dairy cream of claim 1, comprising the following steps:
melting and heating a non-hydrogenated vegetable oil to 60-65° C.;
adding sorbitan monostearate, stearyl monoglyceridyl citrate, lactate monoglyceride, sodium stearoyl lactylate, mono- and diglycerides of fatty acids, sucrose fatty acid ester, polyglycerol ester, carrageenan, microcrystalline cellulose, modified cellulose, sodium caseinate, and potassium dihydrogen phosphate to the non-hydrogenated vegetable oil to produce a first mixture;
stirring the first mixture to disperse evenly to obtain an oil phase;
dissolving sugar, glucose syrup, and fat-containing dairy product in water at 60-70° C. to obtain an aqueous phase;
adding the aqueous phase to the oil phase to produce a second mixture;
stirring evenly and performing pasteurization on the second mixture to produce a pasteurized mixture;
performing homogenization of the pasteurized mixture to produce a homogenized product; and
stirring the homogenized product at a temperature below 10° C. for 1 hour to produce the non-hydrogenated mixed dairy and non-dairy cream.

5. The method for preparing the non-hydrogenated mixed dairy and non-dairy cream of claim 4, further comprising filling a container with the non-hydrogenated mixed dairy and non-dairy cream.

6. The method for preparing the non-hydrogenated mixed dairy and non-dairy cream of claim 5, further comprising keeping the container under a frozen condition below −18° C.

7. The method for preparing the non-hydrogenated mixed dairy and non-dairy cream of claim 4, wherein the non-hydrogenated vegetable oil is prepared from refined palm oil and coconut oil.

8. The method for preparing the non-hydrogenated mixed dairy and non-dairy cream of claim 4, wherein a ratio of the refined palm oil to the coconut oil is 9-10:2-3.
